(19) United States
(12) Patent Application Publication
(10) Pub. No.: US 2022/0104189 A1
(43) Pub. Date: Mar. 31, 2022

(54) TERMINAL AND RADIO COMMUNICATION METHOD

(71) Applicant: NTT DOCOMO, INC., Tokyo (JP)

(72) Inventors: Kazuaki Takeda, Chiyoda-ku, Tokyo (JP); Hiroki Harada, Tokyo (JP)

(73) Assignee: NTT DOCOMO, INC., Tokyo (JP)

(21) Appl. No.: 17/427,349

(22) PCT Filed: Feb. 1, 2019
(86) PCT No.: PCT/JP2019/003728

§ 371 Date: Jul. 30, 2021

(51) Int. Cl. H04W 72/04; H04L 5/00

(52) U.S. Cl. CPC H04W 72/046; H04W 72/0406; H04L 5/0053

(57) ABSTRACT

In order to appropriately control communication even in a case where a large number of terminals exists in a radio communication system, an aspect of a terminal of the present disclosure include: a transmitting/receiving section that performs transmission and reception with another terminal; and a control section that performs control to share at least one of information regarding a transmission configuration indicator state (TCI state), information regarding quasi-co-location (QCL), and position information with the another terminal.

### TECHNICAL FIELD

The present disclosure relates to a terminal and a radio communication method in next-generation mobile communication systems.

### BACKGROUND ART

In a universal mobile telecommunications system (UMTS) network, Long Term Evolution (LTE) has been specified for the purpose of further high-speed data rate, low latency, and the like (see Non Patent Literature 1). LTE-Advanced (3GPP Rel. 10 to 14) has been specified for the purpose of further larger capacity and sophistication of LTE (third generation partnership project (3GPP) release (Rel.) 8, 9).

Successor systems of LTE (for example, 5th generation mobile communication system (5G), 5G+(plus), New Radio (NR), New radio access (NX), Future generation radio access (FX), 3GPP Rel. 15 or later versions) are also under study.

In LTE (e.g., LTE Rel. 13 to 15), everything (e.g., object having a sensor and a communication function) is connected to the Internet. Machine type communication (MTC) and narrow band Internet of Things (NB-IoT) have been specified as Internet of Things (IoT) that exchanges various pieces of data (e.g., measurement data, sensor data, and control data, and the like). MTC and NB-IoT introduced in LTE are also referred to as LTE-IoT or the like.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In a future radio communication system (for example, NR), it is assumed that everything (for example, an object having a sensor and a communication function) is connected to the Internet, and the number of terminals having a communication function increases on the network.

In this case, when each terminal controls communication similarly to the base station, the communication capacity (for example, the communication capacity between each terminal and the base station) in the communication system increases, and there is a possibility that the communication quality deteriorates.

Therefore, an object of the present disclosure is to provide a terminal and a radio communication method capable of appropriately controlling communication even when a large number of terminals exists in a radio communication system.

### Solution to Problem

A terminal according to an aspect of the present disclosure includes: a transmitting/receiving section that performs transmission and reception with another terminal; and a control section that performs control to share at least one of information regarding a transmission configuration indicator state (TCI state), information regarding quasi-co-location (QCL), and position information with the another terminal.

### Advantageous Effects of Invention

According to one aspect of the present disclosure, communication can be appropriately controlled even when a large number of terminals exists in a network.

### BRIEF DESCRIPTION OF DRAWINGS

FIGS. 1A to 1C are diagrams illustrating an example of a relationship between LTE-IoT, eMBB, URLLC, and NR-IoT.

FIG. 2 is a diagram illustrating an example of a requirement targeted by NR-IoT.

FIG. 3 is a diagram illustrating an example of a radio communication system in which a plurality of terminals exists.

FIG. 4 is a diagram illustrating an example of a plurality of terminals having the same geographical position.

FIG. 5 is a diagram illustrating an example of a case where given information is shared among a plurality of terminals having the same geographical position.

FIG. 6 is a diagram illustrating an example of a case where geographical positions are separated.

FIG. 7 is a diagram illustrating an example of a schematic configuration of a radio communication system according to one embodiment.

FIG. 8 is a diagram illustrating an example of a configuration of a base station according to one embodiment.

FIG. 9 is a diagram illustrating an example of a configuration of user terminal according to one embodiment.

FIG. 10 is a diagram illustrating an example of a hardware configuration of the base station and the user terminal according to one embodiment.

### DESCRIPTION OF EMBODIMENTS

In LTE, for example, MTC and NB-IoT are introduced as technologies related to IoT. In MTC, communication of at least one of uplink (UL) and downlink (DL) (UL/DL)) is performed by using a bandwidth narrower than the maximum bandwidth (e.g., 20 MHz) per cell (also referred to as serving cell, component carrier (CC), carrier, and the like) of LTE as the maximum bandwidth.

For example, the maximum bandwidth of MTC is 1.4 MHz or 5 MHz. In a case where sub-carrier spacing (SCS) is 15 kHz, six resource blocks (physical resource block (PRB)) may constitute 1.4 MHz. In addition, in a case where the SCS is 15 kHz, 25 PRBs may constitute 5 MHz. The band for MTC is also called a narrow band (NB), and may be identified by a given index (e.g., narrow band index).

MTC is also called enhanced MTC (eMTC), LTE-MTC (LTE-M), LTE-M1, low cost-MTC (LC-MTC), and the like. Furthermore, a device that performs MTC is also called an MTC terminal, at least one UE (BL/CE UE) of bandwidth reduced low complexity (BL) and coverage enhancement (CE), or the like.

In the NB-IoT, for example, UL/DL communication is performed by using a bandwidth (e.g., 200 kHz) narrower than the maximum bandwidth of MTC as the maximum bandwidth. For example, the maximum bandwidth of the NB-IoT is 200 kHz. In a case where the sub-carrier spacing is 15 kHz, 1 PRB may constitute 200 kHz. NB-IoT is also called narrow band LTE (NB-LTE), narrow band cellular Internet of Things (NB cellular IoT), clean slate, and the like.

In the NR, in addition to a service (for example, enhanced mobile broad band (eMBB) or the like) in which at least one of high speed and large capacity is set as a requirement, it is assumed that a service (for example, ultra reliable and low latency communications (URLLC), vehicle-to-everything (V2X), and the like) of a new requirement (for example, at least one of low latency and high reliability) is studied. The NR-based technology assuming a service of a new requirement is also called NR-IoT, 5G IoT, or the like.

As the technology related to the NR-IoT, for example, at least one of the following may be assumed.
Industrial IoT (also referred to as URLLC or the like)
Internet of Health Things (IoHT) that enables a user (for example, a patient) and a medical institution or company to be connected via a network and perform diagnosis, symptom improvement, health promotion, and the like
Wearable IoT (also referred to as a wearable device, wearable terminal, or the like)
A smart meter capable of transmitting a measurement result of a usage amount (for example, electricity, gas, and the like) to a server
IoT relay

In the NR-IoT as described above, it may be specified by at least one axis (dimension) of data rate (throughput), latency (lower latency), reliability, cost, capacity, mobility, coverage, power consumption, and massive connectivity.

Furthermore, various types of future devices may be considered in the NR-IoT. For example, the type of the device (terminal) may be at least one of wearable, augmented reality (AR), virtual reality (VR), and mixed reality (MR).

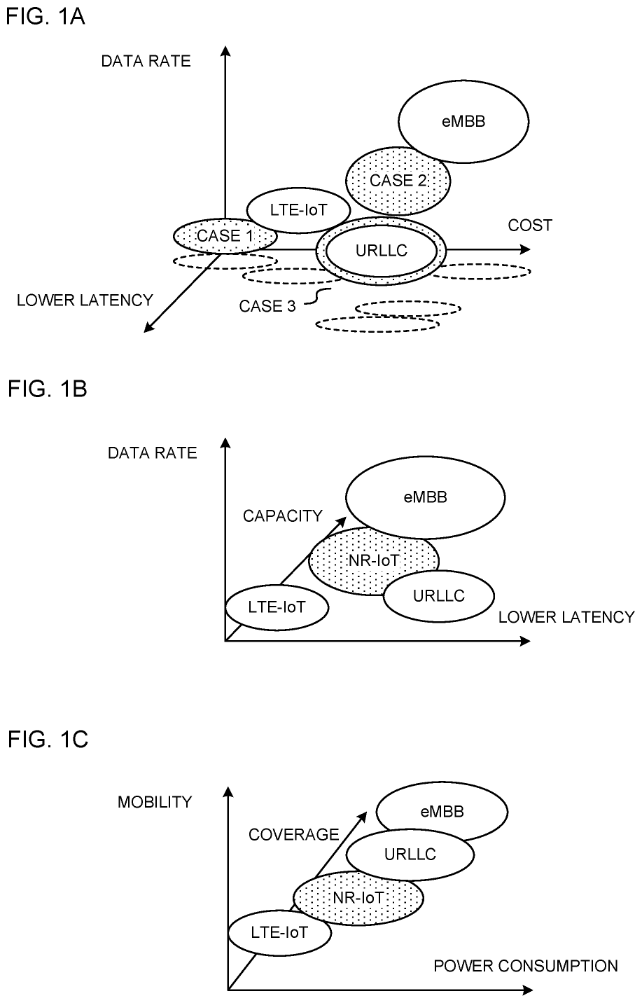

FIGS. 1A to 1C are diagrams illustrating an example of a relationship between LTE-IoT, eMBB, URLLC, and NR-IoT. As illustrated in FIG. 1A, in a case of using three dimensions: data rate, cost, and low latency, at least one of Cases 1 to 3 may be assumed in the NR-IoT.

As illustrated in FIG. 1A, Case 1 includes a terminal with low cost. The terminal may not be required to have a low latency and need not be required to have a high data rate. For example, the terminal in Case 1 may satisfy at least one of an extremely low cost and extremely high energy efficiency terminal (almost cost-zero and ultra energy efficient terminal). Specifically, the terminal may satisfy at least one of almost zero product cost and charging using renewable energy or wireless power transfer.

Case 2 includes a terminal having a medium data rate (throughput). It is sufficient if the data rate (throughput) of the terminal is between LTE IoT (for example, up to 1 Mbps) and eMBB (for example, 2.5 Gbps to 5 Gbps), for example, 10 Mbps to 100 Mbps. The terminal in Case 2 may be used for, for example, video surveillance (video-surveillance).

Note that, as illustrated in FIG. 1A, the terminal in Case 2 may satisfy a medium cost (for example, cost higher than LTE-IoT and lower than eMBB) and a medium low latency (for example, cost higher than LTE-IoT and lower than eMBB).

As Case 3, there is a terminal (for example, a terminal for URLLC is included) having a high requirement for low latency. The terminal may satisfy a medium cost (for example, cost higher than LTE-IoT and lower than eMBB), and the requirement for data rate need not be high. The terminal in Case 3 may be used for real-time monitoring and analysis, a remote control drone, intelligent devices, and the like.

Note that although not illustrated, a dimension of massive connectivity may be added in FIG. 1A. A terminal suitable for massive connectivity may accelerate smart city and manufacturing.

FIG. 1B illustrates a relationship between LTE-IoT, eMBB, URLLC, and NR-IoT using three dimensions: data rate (throughput), capacity, and low latency. As illustrated in FIG. 1B, the NR-IoT may have a higher data rate (for example, a data rate close to eMBB), a lower latency (for example, a low latency close to URLLC).

FIG. 1C illustrates a relationship between LTE-IoT, eMBB, URLLC, and NR-IoT using three dimensions: mobility, coverage, and power consumption. As illustrated in FIG. 1C, the NR-IoT may support medium to high mobility (middle-to-high mobility) (for example, mobility higher than LTE-IoT and lower than URLLC), assuming utilization of a higher carrier frequency (for example, 3.5 GHz).

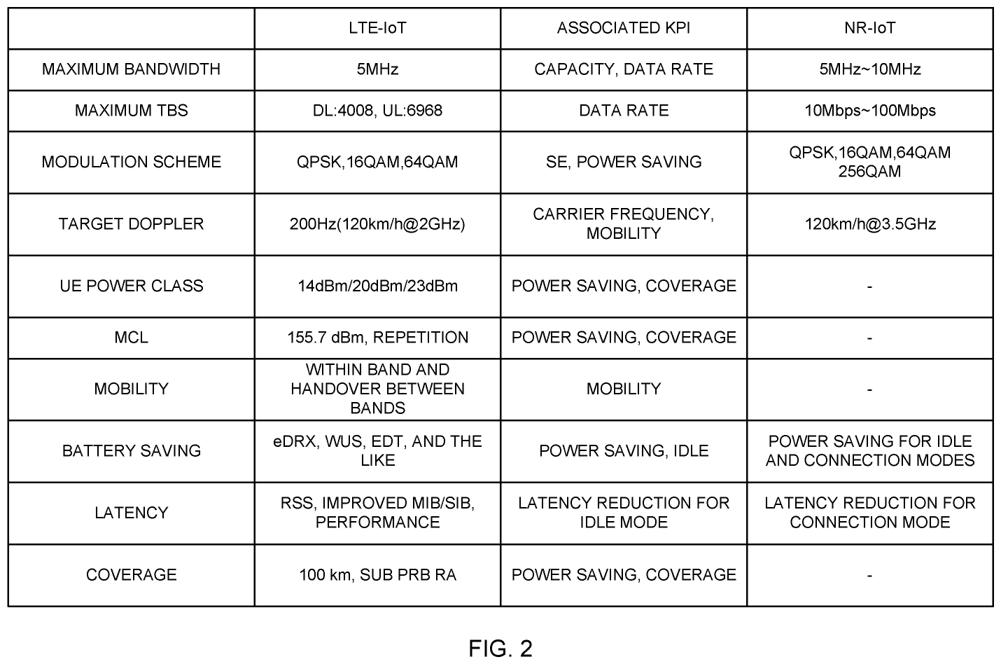

FIG. 2 is a diagram illustrating an example of a requirement targeted by NR-IoT. As illustrated in FIG. 2, the NR-IoT requirement may be specified by at least one of a maximum bandwidth, a maximum transport block size (TBS), a modulation scheme, a target Doppler, a power class of a terminal (user equipment (UE)), a maximum coupling loss (MCL), mobility, battery saving, latency, and coverage.

In FIG. 2, requirements of NR-IoT and LTE-IoT and an index indicating an intermediate goal (key performance indicator (KPI)) are illustrated for each item, which is the requirement. Note that the items and numerical values of the items, which are the requirements, illustrated in FIG. 2 are merely examples, and are not limited to those illustrated.

As illustrated in FIG. 2, the maximum bandwidth of the NR-IoT is, for example, 5 MHz to 10 MHz, and may have a maximum bandwidth wider than that of the LTE-IoT. Furthermore, the maximum TBS of the NR-IoT may be larger than the maximum TBS of at least one of uplink and downlink of the LTE-IoT. Furthermore, the modulation scheme of the NR-IoT may support a higher order modulation scheme than that of the LTE-IoT (for example, 256 QAM).

Furthermore, in the NR-IoT, a Doppler frequency having a moving speed equivalent to that of the LTE-IoT (for example, 120 km/h) (for example, in LTE-IoT, 120 km/h at 2 GHz) at a frequency higher than that of the LTE-IoT (for example, 3.5 GHz) may be targeted.

Furthermore, in the NR-IoT, the power class of the UE, the maximum coupling loss (MCL), the mobility, and the coverage need not be included in or may be included in the requirements. Note that the coupling loss may be defined by a propagation loss according to a separation distance of a cell radius from the base station, the cell radius being a distance from the base station capable of providing a certain communication speed.

Furthermore, in the NR-IoT, power saving for an idle mode and a connected mode (also referred to as an RRC idle mode, an RRC connection mode, and the like) may be specified as the requirement. Furthermore, in the NR-IoT, latency reduction for the connection mode may be specified as the requirement.

As described above, in the NR-IoT, a medium requirement (for example, a requirement higher than LTE-IoT and lower than eMBB) may be specified for one or more items. Note that the above NR-IoT requirements are merely examples, and are not limited to those described above. It is sufficient if the NR-IoT requirements are those specified assuming at least a use case different from that of the eMBB.

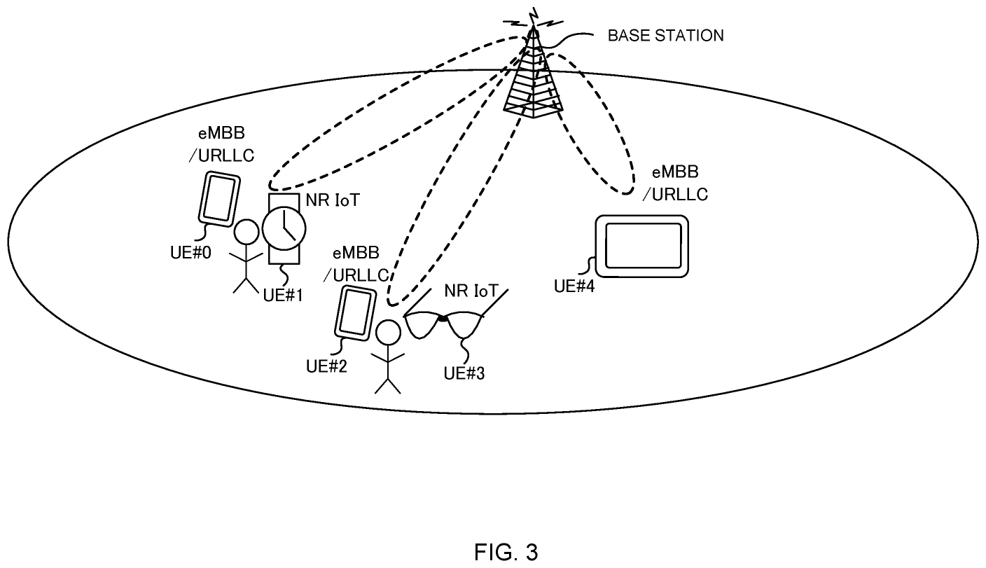

By the way, in NR, in a case where NR-IoT is supported, it is assumed that the number of terminals (hereinafter, also referred to as UE) having a communication function increases on the network (see FIG. 3). FIG. 3 is a diagram illustrating an example of a network in which a terminal using eMBB or URLLC and a terminal using NR-IoT exist.

For example, in FIG. 3, UE #0, UE #2, and UE #4 perform communication with a base station using at least one of eMBB and URLLC (hereinafter, also referred to as eMBB/URLLC). UE #1 and UE #3 perform communication using the NR-IoT (NR-IoT communication) with the base station.

In the NR-IoT communication illustrated in FIG. 3, the same numerology as the NR (for example, eMBB/URLLC communication) may be used. The numerology may be paraphrased, for example, as sub-carrier spacing (SCS) or symbol length. For example, at least one of 15 kHz, 30 kHz, 60 kHz, 120 kHz, and 240 kHz may be supported as the SCS. Note that the SCS and the symbol length may have a reciprocal relationship.

Furthermore, in the NR-IoT communication, at least one of a slot and a time unit shorter than the slot (also referred to as a subslot, a mini slot, or the like) may be supported. The slot may include, for example, 14 symbols. In addition, the subslot may include seven symbols, three or four symbols, or two symbols.

Furthermore, simplified beam management may be supported in the NR-IoT communication. For example, the UE may have a given number of antennas (for example, one or two antennas). In addition, the UE may support a higher order modulation scheme (for example, 256 QAM). On the other hand, in the eMBB/URLLC communication, beam management that is more advanced than that of the NR-IoT communication may be supported.

As illustrated in FIG. 3, in a communication system in which a large number of terminals having a communication function exists, when each terminal controls communication similarly to a base station, processing loads of the terminal and the base station increase with an increase in communication capacity, and there is a possibility that communication quality deteriorates.

As described above, in the NR radio communication system (for example, a communication system in which NR-IoT is supported), it is required to suppress an increase in communication capacity.

By the way, in a communication system in which a plurality of terminals exists, a case where a plurality of terminals existing in the same geographical location (for example, owned by the same user) communicates with the base station is also assumed. FIG. 3 illustrates a case where UE #0 and UE #1 exist in the same geographical location, and UE #2 and UE #3 exist in the same geographical location.

The present inventors have conceived that, in such a case, communication processing between the base station and the terminal can be reduced by performing a given communication operation (or radio processing) in another terminal using some of the terminals instead of given terminals (for example, a plurality of terminals existing in the same geographical location) separately communicating with the base station.

Hereinafter, embodiments according to the present disclosure will be described in detail with reference to the drawings. In the following description, a case where a plurality of communications is eMBB/URLLC communication and NR-IoT communication will be exemplified, but it is not limited thereto.

Furthermore, in the NR-IoT communication, a given channel and/or signal (channel/signal) is used in the same manner as in the NR (for example, eMBB/URLLC communication), but may be specified independently of the NR. It is sufficient if the given channel/signal is at least one of a broadcast channel (Physical Broadcast Channel (PBCH)), a downlink control channel (Physical Downlink Control Channel (PDCCH)), a downlink shared channel (Physical Downlink Shared Channel (PDSCH)), a random access channel (Physical Random Access Channel (PRACH)), an uplink shared channel (Physical Uplink Shared Channel (PUSCH)), a primary synchronization signal (PSS), a secondary synchronization signal (SSS), and a reference signal (RS).

Information (for example, any character string) indicating that it is for NR-IoT may be added to such channel/signal for NR-IoT communication to distinguish it from each channel/signal for NR. For example, a PDCCH for NR-IoT may be referred to as an XPDCCH (X is an arbitrary character string). The same applies to the other channels. Note that a channel/signal having the same name as that of the NR may be used as at least a part of the channel/signal for NR-IoT communication.

Furthermore, the terminal described in the following description is not limited to the NR-IoT terminal, and can also be applied to a NB-IoT terminal, an eMTC terminal, or a terminal other than an IoT terminal in NR.

(Implementation)

In the present implementation, given information (for example, at least one of TCI information, QCL information, and position information) is shared between terminals using terminal-to-terminal communication, and a given communication operation of another terminal is performed using some terminals.

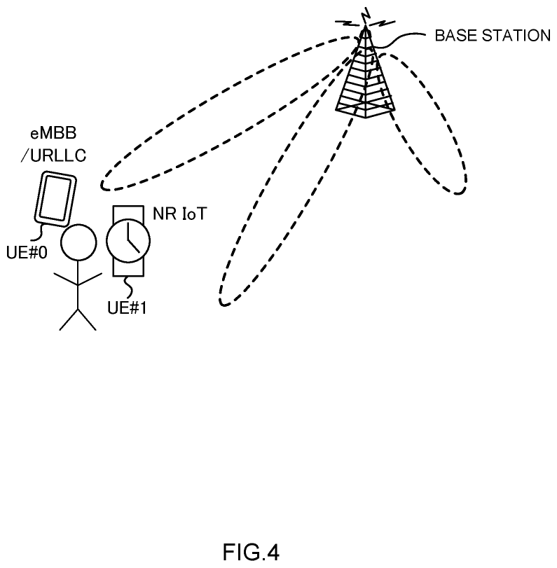

FIG. 4 illustrates an example of a radio communication system in which terminal #0 (UE #0) and terminal #1 (UE #1) exist. Here, a case where terminal #0 is a terminal that performs eMBB/URLLC communication (for example, a smartphone) and terminal #1 is a terminal that performs NR-IoT communication (for example, a wristwatch-type wearable device) will be described, but the number of terminals and the communication type applied by the terminal are not limited thereto. For example, both terminal #0 and terminal #1 may be terminals that perform NR-IoT communication.

Furthermore, in the NR-IoT communication, connection with a plurality of RATS (for example, LTE and NR) (multi-connectivity) or connection with a single RAT (for example, NR) may be supported.

Terminal #0 and terminal #1 may transmit and receive information by terminal-to-terminal communication (device to device (D2D), for example, sidelink (SL), Bluetooth (registered trademark), or the like). Alternatively, terminal-to-terminal communication may be performed using an unlicensed band that requires a listening (or LBT) operation before transmission.

For example, terminal #0 and terminal #1 may share at least one of information regarding a transmission configuration indicator (or transmission configuration indication (TCI)) state (TCI state), information regarding quasi-co-location (QCL), and position information using the terminal-to-terminal communication. As a result, it is possible to determine whether or not the terminals exist at the same geographical position (or whether or not the same beam can be used for transmission and reception).

The transmission configuration indication or transmission configuration indicator (TCI) state (TCI state) may indicate the QCL information of a given channel/signal (for example, PDSCH, PDCCH, PUCCH, or PUSCH). The base station may configure a given TCI state for each terminal.

The TCI state may be identified by a given indicator (TCI state ID (TCI-StateId)), and may indicate (include) information regarding the QCL (QCL information (QCL-Info)) between a target channel/signal (or a reference signal for the channel (or an antenna port of the reference signal)) and another signal (for example, another downlink reference signal (DL-RS) or uplink reference signal (UL-RS)).

Each TCI state may indicate (include) QCL information for a given channel (for example, PDSCH). One or more TCI states (QCL information for one or more PDSCHs) may be notified (configured) to the UE from the base station by higher layer signaling (for example, RRC signaling).

The DCI (DL assignment, for example, DCI format 1_1) used for PDSCH scheduling may include a given field (which may be referred to as, for example, transmission configuration indicator (TCI field, TCI state field, or the like) indicating a TCI state (QCL information for the PDSCH). The TCI field may include a given number of bits (for example, 3 bits).

For example, when the DCI includes a 3-bit TCI field, a radio base station may preliminarily configure up to eight types of TCI states in the user terminal by higher layer signaling. A value of the TCI field in the DCI (TCI field value) may indicate one of the TCI states preliminarily configured by higher layer signaling.

The QCL (Quasi-Co-Location) is an indicator indicating statistical properties of the channel/signal, and is also called a quasi-co-location. The user terminal (UE) may control reception processing or transmission processing of a given channel/signal on the basis of information regarding a QCL (QCL information) of at least one of the given channel and signal (channel/signal). The reception processing corresponds to, for example, at least one of demapping, demodulation, and decoding. The transmission processing corresponds to at least one of mapping, modulation, and encoding.

For example, when one signal and another signal have a QCL relationship, this may mean that it is possible to assume that the plurality of different signals have at least one identical property (QCL is established regarding at least one of these) out of: Doppler shift, Doppler spread, average delay, delay spread, and spatial parameter (for example, spatial reception parameter (spatial Rx parameter)).

Note that the spatial reception parameter may correspond to a reception beam (for example, reception analog beam) or a transmission beam (for example, transmission analog beam) of the user terminal, and the beam may be specified on the basis of spatial QCL. In the present disclosure, the QCL and at least one element of the QCL, may be read as sQCL (spatial QCL).

A plurality of types of QCL (QCL type) may be defined. For example, four QCL types A to D with different parameters (or parameter sets) that can be assumed to be the same may be provided, and the parameters are shown below:
QCL type A: Doppler shift, Doppler spread, average delay, and delay spread,
QCL Type B: Doppler shift and Doppler spread,
QCL type C: Doppler shift and average delay, and
QCL type D: spatial reception parameter.

The QCL information may include, for example, at least one of information regarding a DL-RS or a UL-RS (hereinafter, also simply referred to as an RS) (RS relation information) having a QCL relationship with the target channel/signal, information indicating the above-described QCL type (QCL type information), and information regarding a carrier (cell) in which the RS is arranged and a BWP.

The RS relation information may include information indicating at least one of the RS having the QCL relationship with the target channel/signal and a resource of the RS. For example, when a plurality of reference signal sets (RS sets) are configured in the user terminal, the RS relation information may indicate at least one of an RS having the QCL relationship with a channel (or a port for the channel) among RSs included in the RS set, a resource for the RS, and the like.

The DL-RS may be, for example, at least one of a synchronization signal (SS), a broadcast channel (PBCH: Physical Broadcast Channel), a synchronization signal block (SSB), a Mobility RS (MRS), a channel state information-reference signal (CSI-RS), a CSI-RS for tracking, a beam-specific signal, and the like, or a signal (for example, a signal formed by changing at least one of a density or a cycle) configured by expanding or changing these.

The synchronization signal may be, for example, at least one of a primary synchronization signal (PSS) and a secondary synchronization signal (SSS). The SSB is a signal block including a synchronization signal and a physical broadcast channel, and may be referred to as an SS/PBCH block or the like.

The UL-RS may be, for example, a sounding reference signal (SRS).

<Group Formation>

The terminals may be grouped on the basis of given conditions. For example, another terminal belonging to the same group as the own terminal may be determined on the basis of information (for example, information regarding the TCI state, information regarding the QCL, or position information) shared between the terminals. For example, terminal #0 may be determined to belong to the same group as (or establish pairing with) a terminal (for example, terminal #1) for which at least one of the TCI state and the QCL to be configured is the same.

Alternatively, terminal #0 may be determined to belong to the same group as a terminal for which at least one of the TCI state and the QCL is the same and that is recognized in advance (for example, a terminal registered in terminal #0). For example, terminal #0 may perform pairing when terminal #1 is registered in terminal #0 in advance.

Alternatively, terminal #0 may receive information regarding terminals belonging to the same group from the network (for example, the base station).

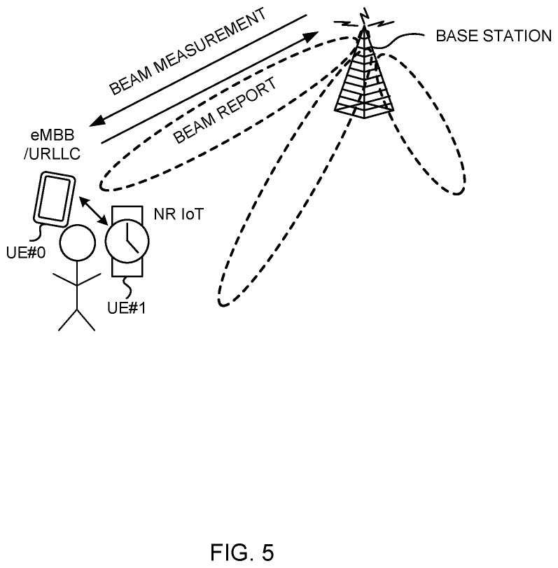

FIG. 5 illustrates a case where terminal #0 and terminal #1 belong to the same group (for example, the TCI state or QCL is the same). Each terminal may assume that at least one of the same transmission beam and reception beam is applied to terminals belonging to the same group.

In a case where a plurality of terminals is included in the given group, a given communication operation (for example, a given transmission operation or a given reception operation) of another terminal may be performed using a specific terminal. The given communication operation may be at least one of beam management, beam report, beam failure occurrence report, and beam recovery request. Alternatively, the operation may be a communication operation other than the beam-related operations.

For example, a specific terminal (for example, it is also referred to as a representative terminal) may be determined from a plurality of terminals included in the same group. In FIG. 5, when terminal #0 is the representative terminal, terminal #0 may perform the given transmission operation or reception operation corresponding to terminal #1 instead of terminal #1.

For example, terminal #1 may request terminal #0 regarding beam-related operations (for example, beam management operation (for example, at least one of transmission and reception of information regarding beam management, beam recovery request, and the like), update of TCI information, or the like. In response to a request from terminal #1, terminal #0 performs at least one of transmission and reception of information regarding beam management corresponding to terminal #1, request of update of information regarding the TCI state, and a beam recovery request in the network (for example, the base station).

The base station may collectively or simultaneously perform configuration or reconfiguration processing on a terminal having at least one of the same TCI state, QCL, and position information. Alternatively, the base station may selectively notify the representative terminal of the configuration information. The configuration information may be at least one of information regarding beam operation such as beam management, information regarding the TCI state to be configured, and information regarding the QCL.

As described above, the terminals belonging to the same group perform the given communication operation via the representative terminal, and it is possible to omit transmission and reception with the base station by each terminal. As a result, the communication capacity between many terminals and the base station can be reduced.

<Measurement>

At least one of terminal #0 and terminal #1 belonging to the same group may perform measurement on the basis of a DL reference signal (for example, CSI-RS, SS/PBCH block, and the like) transmitted from the base station.

In a case where both terminal #0 corresponding to the representative terminal and terminal #1 corresponding to another terminal perform measurement, the measurement conditions may be configured separately. The measurement conditions may be, for example, at least one of a measurement cycle, a report cycle, a type of a reference signal used for measurement, and a channel used for report. For example, at least one of the measurement cycle and the report cycle of terminal #0 may be configured to be shorter than the measurement cycle and the report cycle of terminal #1.

Terminal #1 may transmit given information to the base station via terminal #0 in a case where measurement quality (for example, reception beam quality) is lower than a given value by the measurement. The given information may be at least one of a measurement result, beam failure detection, a beam recovery request, and a TCI update request.

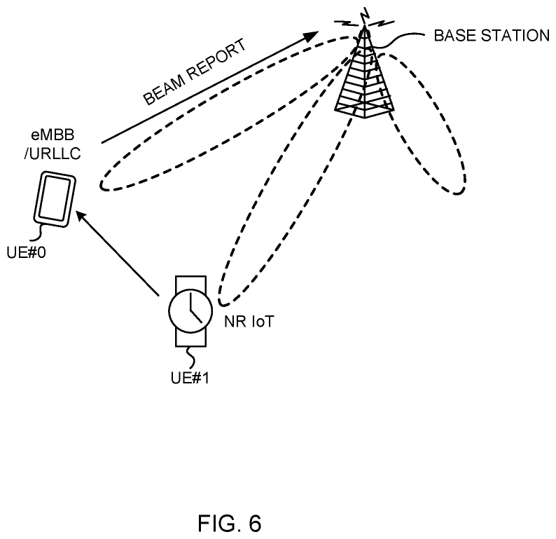

For example, a case where the position of terminal #1 moves and moves away from the position of terminal #0 is assumed (see FIG. 6). In this case, in a state where the same beam as that of terminal #0 is applied to terminal #1, the reception quality of terminal #1 deteriorates. Terminal #1 may transmit at least one of the beam failure detection and the beam recovery request to the base station via terminal #0 when the reception quality becomes lower than a given value by the measurement. By performing transmission to the base station via terminal #0, even when the quality of reception from the base station is deteriorated (when a beam failure occurs) in terminal #1, it is possible to give a notification to the base station. Further, terminal #1 may notify the base station of the update of the TCI state via terminal #0.

When receiving at least one of the beam failure detection and the beam recovery request corresponding to terminal #1 from terminal #0, the base station may switch the beam to be applied to terminal #1. At this time, the base station may perform a beam failure recovery operation corresponding to terminal #1 via terminal #0.

(Radio Communication System)

Hereinafter, a configuration of a radio communication system according to one embodiment of the present disclosure will be described. In the radio communication system, communication is performed by using one or a combination of the above-described radio communication methods according to the embodiments of the present disclosure.

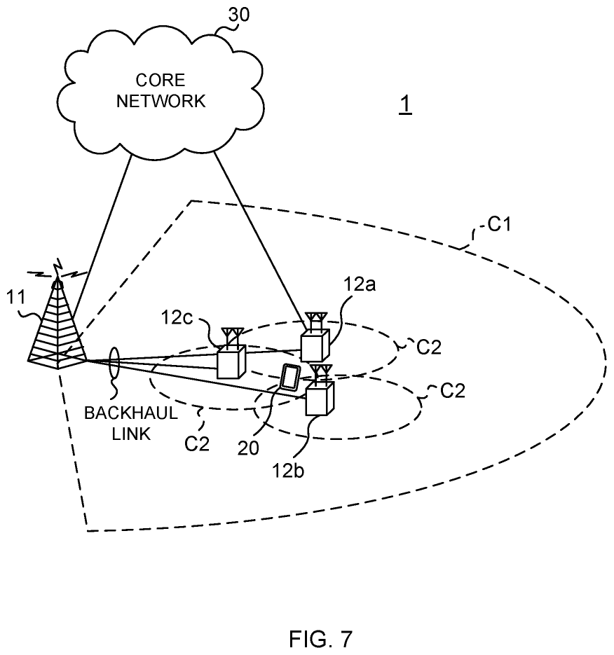

FIG. 7 is a diagram illustrating an example of a schematic configuration of a radio communication system according to one embodiment. A radio communication system 1 may be a system that implements communication using Long Term Evolution (LTE), 5th generation mobile communication system New Radio (5G NR), and the like specified by Third Generation Partnership Project (3GPP).

The radio communication system 1 may support dual connectivity (multi-RAT dual connectivity (MR-DC)) between a plurality of pieces of radio access technology (RAT). MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In EN-DC, an LTE (E-UTRA) base station (eNB) is a master node (MN), and an NR base station (gNB) is a secondary node (SN). In NE-DC, the NR base station (gNB) is MN, and an LTE (E-UTRA) base station (eNB) is SN.

The radio communication system 1 may support dual connectivity between a plurality of base stations in the same RAT (e.g., dual connectivity in which both MN and SN are NR base stations (gNB) (NR-NR dual connectivity (NN-DC)).

The radio communication system 1 may include a base station 11 and base stations 12 (12a to 12c). The base station 11 forms a macro cell C1 with a relatively wide coverage. The base stations 12 (12a to 12c) are disposed in the macro cell C1, and form a small cell C2 narrower than the macro cell C1. User terminal 20 may be located in at least one cell. The arrangement, number, and the like of cells and the user terminal 20 are not limited to the aspects illustrated in the drawings. The base stations 11 and 12 will be collectively referred to as base stations 10 unless these base stations are distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range (frequency range 1 (FR1)) and a second frequency range (frequency range 2 (FR2)). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of FR1 and FR2 are not limited thereto, and FR1 may correspond to a frequency range higher than FR2, for example.

The user terminal 20 may perform communication in each CC by using at least one of time division duplex (TDD) and frequency division duplex (FDD).

The plurality of base stations 10 may be connected by wire (e.g., optical fiber in compliance with common public radio interface (CPRI) or an X2 interface) or by radio (e.g., NR communication). For example, when NR communication is used as backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include at least one of, for example, an evolved packet core (EPC), a 5G core network (5GCN), and a next generation core (NGC).

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (e.g., another single carrier transmission method and another multi-carrier transmission method) may be used as UL and DL radio access methods.

In the radio communication system 1, a downlink shared channel (physical downlink shared channel (PDSCH)) shared by each user terminal 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by each user terminal 20, an uplink control channel (physical uplink control channel (PUCCH)), a random access channel (physical random access channel (PRACH)), and the like may be used as uplink channels.

User data, higher layer control information, a system information block (SIB), and the like are transmitted by the PDSCH. User data, higher layer control information, and the like may be transmitted by the PUSCH. Master information block (MIB) may be transmitted by the PBCH.

Lower layer control information may be transmitted by the PDCCH. The lower layer control information may include, for example, downlink control information (DCI) including scheduling information of at least one of the PDSCH and the PUSCH.

Note that, the DCI that schedules the PDSCH may be referred to as DL assignment, DL DCI, and the like, and the DCI that schedules the PUSCH may be referred to as UL grant, UL DCI, and the like. Note that the PDSCH may be replaced with DL data, and the PUSCH may be replaced with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or a plurality of search spaces. The UE may monitor the CORESET associated with a certain search space on the basis of the search space configuration.

One search space may correspond to a PDCCH candidate corresponding to one or a plurality of aggregation levels. One or a plurality of search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery confirmation information (which may be referred to as, e.g., hybrid automatic repeat request acknowledgement (HARQ-ACK), ACK/NACK, and the like), and scheduling request (SR) may be transmitted by the PUCCH. A random access preamble for establishing connection with a cell may be transmitted by the PRACH.

Note that, in the present disclosure, downlink, uplink, and the like may be expressed without “link”. Furthermore, various channels may be expressed without “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as DL-RS.

The synchronization signal may be at least one of, for example, a primary synchronization signal (PSS) and a secondary synchronization signal (SSS). A signal block including SS (PSS and SSS) and PBCH (and DMRS for PBCH) may be referred to as an SS/PBCH block, an SS block (SSB), and the like. Note that SS, SSB, and the like may also be referred to as a reference signal.

Furthermore, in the radio communication system 1, a sounding reference signal (SRS), a demodulation reference signal (DMRS), and the like may be transmitted as an uplink reference signal (UL-RS). Note that, DMRSs may be referred to as “user terminal-specific reference signals (UE-specific Reference Signals).”

(Base Station)

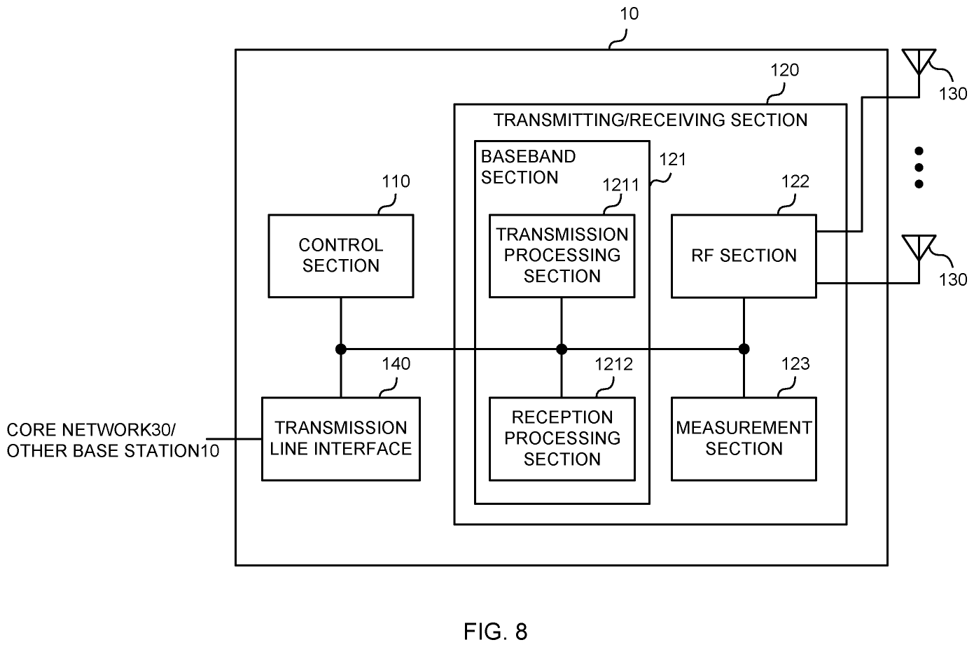

FIG. 8 is a diagram illustrating an example of a configuration of a base station according to one embodiment. The base station 10 includes a control section 110, a transmitting/receiving section 120, a transmission/reception antenna 130, and a transmission line interface 140. Note that one or more of the control sections 110, one or more of the transmitting/receiving sections 120, one or more of the transmission/reception antennas 130, and one or more of the transmission line interfaces 140 may be included.

Note that the example mainly describes functional blocks of characteristic parts in the embodiment, and it may be assumed that the base station 10 also includes other functional blocks necessary for radio communication. A part of processing of each section described below may be omitted.

The control section 110 controls the entire base station 10. The control section 110 can include a controller, a control circuit, and the like that are described on the basis of common recognition in the technical field related to the present disclosure.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be transmitted as a signal, control information, a sequence, and the like, and may transfer the data, the control information, the sequence, and the like to the transmitting/receiving section 120. The control section 110 may perform call processing (such as configuration or release) of a communication channel, management of the state of the base station 10, management of a radio resource, and the like.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be constituted as an integrated transmitting/receiving section, or may be constituted by a transmitting section and a receiving section. The transmitting section may be constituted by the transmission processing section 1211 and the RF section 122. The receiving section may be constituted by the reception processing section 1212, the RF section 122, and the measurement section 123.

The transmission/reception antenna 130 can include an antenna described on the basis of common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a transmission beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data or control information acquired from the control section 110 to generate a bit string to be transmitted.

The transmitting/receiving section 120 (transmission processing section 1211) may perform transmission processing such as channel encoding (which may include error correction coding), modulation, mapping, filtering processing, discrete Fourier transform (DFT) processing (if necessary), inverse fast Fourier transform (IFFT) processing, precoding, or digital-analog transform on the bit string to be transmitted, and may output a baseband signal.

The transmitting/receiving section 120 (RF section 122) may perform modulation to a radio frequency range, filtering processing, amplification, and the like on the baseband signal, and may transmit a signal in the radio frequency range via the transmission/reception antenna 130.

Meanwhile, the transmitting/receiving section 120 (RF section 122) may perform amplification, filtering processing, demodulation to a baseband signal, and the like on the signal in the radio frequency range received by the transmission/reception antenna 130.

The transmitting/receiving section 120 (reception processing section 1212) may apply reception processing such as analog-digital transform, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 120 (measurement section 123) may perform measurement on the received signal. For example, the measurement section 123 may perform radio resource management (RRM) measurement, channel state information (CSI) measurement, and the like on the basis of the received signal. The measurement section 123 may measure received power (for example, reference signal received power (RSRP)), reception quality (for example, reference signal reception quality (RSRQ), signal to interference plus noise ratio (SINR), or signal to noise ratio (SNR)), signal strength (for example, received signal strength indicator (RSSI)), propagation path information (for example, CSI), and the like. The measurement result may be output to the control section 110.

The transmission line interface 140 may perform transmission/reception of a signal (backhaul signaling) to/from an apparatus, another base station 10, or the like included in the core network 30, and may perform acquisition, transmission, or the like of user data (user plane data), control plane data, and the like for the user terminal 20.

Note that the transmitting section and the receiving section of the base station 10 in the present disclosure may be constituted by at least one of the transmitting/receiving section 120, the transmission/reception antenna 130, and the transmission line interface 140.

Note that the transmitting/receiving section 120 transmits and receives (at least one of transmission and reception) given information corresponding to another terminal to and from a given terminal. Furthermore, the transmitting/receiving section 120 may transmit information regarding association between terminals (for example, a terminal identifier included in the group). Alternatively, the transmitting/receiving section 120 may receive information regarding association between terminals (for example, a terminal identifier included in the group) from the terminals.

The control section 110 performs control to transmit and receive (at least one of transmission and reception) given information corresponding to another terminal to and from a given terminal.

(User Terminal)

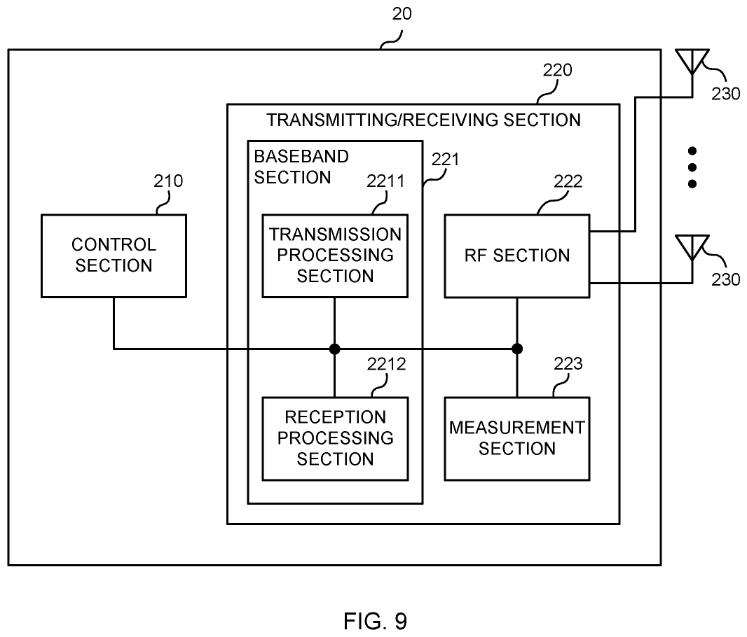

FIG. 9 is a diagram illustrating an example of a configuration of user terminal according to one embodiment. The user terminal 20 includes a control section 210, a transmitting/receiving section 220, and a transmitting/reception antenna 230. Note that one or more of the control sections 210, one or more of the transmitting/receiving sections 220, and one or more of the transmission/reception antennas 230 may be included.

Note that the example mainly describes functional blocks of characteristic parts in the embodiment, and it may be assumed that the user terminal 20 also includes other functional blocks necessary for radio communication. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted by a transmitter/receiver, an RF circuit, a baseband circuit, a filter, a phase shifter, a measurement circuit, a transmitting/receiving circuit, and the like, which are described on the basis of common recognition in the technical field related to the present disclosure.

The transmitting/receiving section 220 may be constituted as an integrated transmitting/receiving section, or may be constituted by a transmitting section and a receiving section. The transmitting section may be constituted by the transmission processing section 2211 and the RF section 222. The receiving section may be constituted by the reception processing section 2212, the RF section 222, and the measurement section 223.

The transmission/reception antenna 230 can be constituted by an antenna described on the basis of common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data or control information acquired from the control section 210 to generate a bit string to be transmitted.

The transmitting/receiving section 220 (transmission processing section 2211) may perform transmission processing such as channel encoding (which may include error correction coding), modulation, mapping, filtering processing, DFT processing (if necessary), IFFT processing, precoding, or digital-analog transform on a bit string to be transmitted, and may output a baseband signal.

Note that whether or not to apply DFT processing may be based on configuration of transform precoding. When transform precoding is enabled for a channel (for example, PUSCH), the transmitting/receiving section 220 (transmission processing section 2211) may perform DFT processing as the transmission processing in order to transmit the channel using a DFT-s-OFDM waveform. When it is not the case, DFT processing may not be performed as the transmission processing.

The transmitting/receiving section 220 (RF section 222) may perform modulation to a radio frequency range, filtering processing, amplification, and the like on the baseband signal, and may transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may acquire user data and the like by applying reception processing such as analog-digital transform, FFT processing, IDFT processing (if necessary), filtering processing, demapping, demodulation, decoding (which may include error correction decoding), MAC layer processing, RLC layer processing, or PDCP layer processing on the acquired baseband signal.

The transmitting/receiving section 220 (measurement section 223) may perform measurement on the received signal. For example, the measurement section 223 may perform RRM measurement, CSI measurement, and the like on the basis of the received signal. The measurement section 223 may measure received power (for example, RSRP), reception quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may be constituted by at least one of the transmitting/receiving section 220 and the transmission/reception antenna 230.

Note that the transmitting/receiving section 220 transmits and receives (at least one of transmission and reception) to and from another terminal by using the terminal-to-terminal communication. For example, the transmitting/receiving section 220 transmits or receives at least one of information regarding the transmission configuration indicator state (TCI state) to be configured, information regarding the quasi-co-location (QCL), and position information to or from another terminal.

The transmitting/receiving section 220 may transmit information regarding association between terminals (for example, a terminal identifier included in the group) to the base station or another terminal. Alternatively, the transmitting/receiving section 120 may receive information regarding association between terminals (for example, a terminal identifier included in the group) from the base station or another terminal.

The transmitting/receiving section 220 may transmit information regarding at least one of the beam management and the beam recovery request of another terminal on the basis of the notification from another terminal.

The transmitting/receiving section 220 may receive a TCI state switching request from another terminal and transmit a TCI state switching request of another terminal to the base station.

The transmitting/receiving section 220 may transmit at least one of the information regarding the beam management, the information regarding the beam recovery request, the information regarding the TCI state, and the information regarding the QCL notified from the base station to another terminal.

The control section 210 performs control such that at least one of information regarding the transmission configuration indicator state (TCI state), information regarding the quasi-co-location (QCL), and position information is shared with another terminal.

The control section 210 may determine the terminals belonging to the same group on the basis of at least one of the information regarding the TCI state of another terminal, the information regarding the QCL, and the position information, or the configuration information from the base station.

The control section 210 may perform control to transmit information regarding at least one of the beam management and the beam recovery request of the another terminal to the base station on the basis of the notification from the another terminal.

The control section 210 may perform control to receive a TCI state switching request from another terminal and transmit a TCI state switching request of another terminal to the base station.

The control section 210 may perform control to transmit at least one of the information regarding the beam management, the information regarding the beam recovery request, the information regarding the TCI state, and the information regarding the QCL notified from the base station to another terminal.

(Hardware Configuration)

Note that the block diagrams that have been used to describe the above embodiments illustrate blocks in functional units. These functional blocks (configuration sections) may be implemented in arbitrary combinations of at least one of hardware and software. Further, the method for implementing each functional block is not particularly limited. That is, each functional block may be implemented by a single apparatus physically or logically aggregated, or may be implemented by directly or indirectly connecting two or more physically or logically separate apparatuses (using wires, radio, or the like, for example) and using these plural apparatuses. The functional blocks may be achieved by combining the one apparatus or the plurality of apparatuses with software.

Here, the functions include, but are not limited to, assessment, determination, judging, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, and assigning. For example, a functional block (configuration section) that causes transmission to function may be called as a transmitting unit, a transmitter and the like. In any case, as described above, the implementation method is not particularly limited.

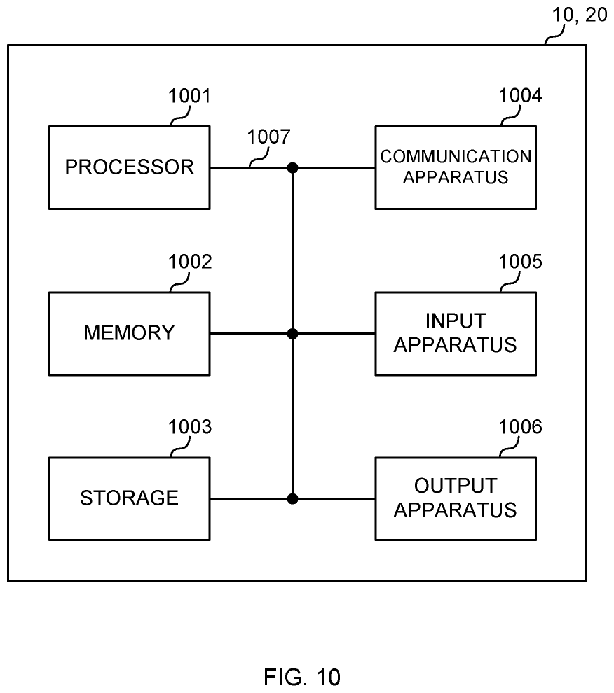

For example, a base station, user terminal, and the like according to one embodiment of the present disclosure may function as a computer that executes the processing of the radio communication method of the present disclosure. FIG. 10 is a diagram illustrating an example of a hardware configuration of the base station and the user terminal according to one embodiment. The above-described base station 10 and user terminal 20 may be physically configured as a computer apparatus including a processor 1001, a memory 1002, a storage 1003, a communication apparatus 1004, an input apparatus 1005, an output apparatus 1006, a bus 1007, and the like.

Note that, in the present disclosure, the word such as an apparatus, a circuit, a device, a section, and a unit can be replaced with each other. The hardware configuration of the base station 10 and the user terminal 20 may be designed to include one or a plurality of each apparatuses illustrated in the drawings, or may be designed not to include some apparatuses.

For example, although only one processor 1001 is illustrated, a plurality of processors may be provided. Further, the processing may be executed by one processor, or the processing may be executed simultaneously, in sequence, or in different manners, by two or more processors. Note that the processor 1001 may be implemented with one or more chips.

Each function of the base station 10 and the user terminal 20 is implemented by reading given software (program) on hardware such as the processor 1001 and the memory 1002, and by controlling the operation in the processor 1001, the communication in the communication apparatus 1004, and at least one of the reading and writing of data in the memory 1002 and the storage 1003.

The processor 1001 may control the whole computer by, for example, running an operating system. The processor 1001 may include a central processing unit (CPU) including an interface with peripheral equipment, a control apparatus, an arithmetic apparatus, a register, and the like. For example, at least a part of the above-described control section 110(210), transmitting/receiving section 120(220), and the like may be implemented by the processor 1001.

Furthermore, the processor 1001 reads, for example, programs (program codes), software modules, or data from at least one of the storage 1003 and the communication apparatus 1004 into the memory 1002, and executes various kinds of processing according to these. As the program, a program to cause a computer to execute at least a part of the operation described in the above-described embodiment is used. For example, the control section 110(210) may be implemented by a control program that is stored in the memory 1002 and operates in the processor 1001, and another functional block may be implemented similarly.

The memory 1002 is a computer-readable recording medium, and may include at least one of, for example, a read only memory (ROM), an erasable programmable rom (EPROM), an electrically EPROM (EEPROM), a random access memory (RAM), and other appropriate storage media. The memory 1002 may be referred to as a register, a cache, a main memory (main storage apparatus), and the like. The memory 1002 can store a program (program code), a software module, and the like, which are executable for implementing the radio communication method according to one embodiment of the present disclosure.

The storage 1003 is a computer-readable recording medium, and may include at least one of, for example, a flexible disk, a floppy (registered trademark) disk, a magneto-optical disk (e.g., compact disc (compact disc ROM (CD-ROM) and the like), digital versatile disc, Blu-ray (registered trademark) disk), a removable disk, a hard disk drive, a smart card, a flash memory device (e.g., card, stick, and key drive), a magnetic stripe, a database, a server, and other appropriate storage media. The storage 1003 may be referred to as an auxiliary storage apparatus.

The communication apparatus 1004 is hardware (transmitting/receiving device) for performing inter-computer communication via at least one of a wired network or a radio network, and is referred to as, for example, a network device, a network controller, a network card, and a communication module. The communication apparatus 1004 may include a high frequency switch, a duplexer, a filter, a frequency synthesizer, and the like in order to implement at least one of, for example, frequency division duplex (FDD) and time division duplex (TDD). For example, the transmitting/receiving section 120(220), the transmission/reception antenna 130(230), and the like described above may be implemented by the communication apparatus 1004. The transmitting/receiving section 120(220) may be implemented by physically or logically separating a transmitting section 120a(220a) and a receiving section 120b(220b) from each other.

The input apparatus 1005 is an input device that receives an input from outside (for example, a keyboard, a mouse, a microphone, a switch, a button, a sensor, and the like). The output apparatus 1006 is an output device for performing outputting to the outside (for example, a display, a speaker, a light emitting diode (LED) lamp, and the like). Note that the input apparatus 1005 and the output apparatus 1006 may be an integrated configuration (e.g., touch panel).

Furthermore, those pieces of apparatuses including the processor 1001, the memory 1002, and the like are connected by the bus 1007 for communicating information. The bus 1007 may be formed with a single bus, or may be formed with buses that vary between apparatuses.

The base station 10 and the user terminal 20 may include hardware such as a microprocessor, a digital signal processor (DSP), an application specific integrated circuit (ASIC), a programmable logic device (PLD), and a field programmable gate array (FPGA), and a part or all of each functional block may be implemented by the hardware. For example, the processor 1001 may be implemented with at least one of these pieces of hardware.

(Variations)

Note that terms described in the present disclosure and terms necessary for understanding the present disclosure may be replaced with other terms that have the same or similar meanings. For example, a channel, a symbol, and a signal (or signaling) may be replaced with each other. Further, the signal may be a message. The reference signal can be abbreviated as an RS, and may be referred to as a pilot, a pilot signal and the like, depending on which standard applies. Further, a component carrier (CC) may be referred to as a cell, a frequency carrier, a carrier frequency, and the like.

A radio frame may include one or more periods (frames) in the time domain. Each of one or a plurality of periods (frames) constituting a radio frame may be referred to as a subframe. Furthermore, a subframe may be constituted by one or a plurality of slots in the time domain. A subframe may be a fixed time duration (e.g., 1 ms) that is not dependent on numerology.

Here, the numerology may be a communication parameter applied to at least one of transmission and reception of a signal or a channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, specific windowing processing performed by a transceiver in the time domain, and the like.

The slot may include one or a plurality of symbols (e.g., orthogonal frequency division multiplexing (OFDM) symbol and single carrier frequency division multiple access (SC-FDMA) symbol) in the time domain. Further, the slot may be a time unit based on numerology.

A slot may include a plurality of mini slots. Each mini slot may be constituted by one or a plurality of symbols in the time domain. Further, a mini slot may be referred to as a subslot. Each mini slot may be constituted by fewer symbols than a slot. A PDSCH (or PUSCH) transmitted in a time unit larger than a mini slot may be referred to as PDSCH (PUSCH) mapping type A. A PDSCH (or PUSCH) transmitted using a mini slot may be called PDSCH (PUSCH) mapping type B.

A radio frame, a subframe, a slot, a mini slot, and a symbol all represent the time unit in signal communication. The radio frame, the subframe, the slot, the mini slot, and the symbol may be each called by other applicable names. Note that time units such as a frame, a subframe, a slot, a mini slot, and a symbol in the present disclosure may be replaced with each other.

For example, one subframe may be referred to as TTI. A plurality of consecutive subframes may be referred to as TTI. One slot or one mini slot may be referred to as TTI. That is, at least one of the subframe and TTI may be a subframe (1 ms) in the existing LTE, may be a period shorter than 1 ms (for example, one to thirteen symbols), or may be a period longer than 1 ms. Note that the unit to represent the TTI may be called a “slot,” a “mini slot”, or the like, instead of a “subframe”.

Here, a TTI refers to the minimum time unit of scheduling in radio communication, for example. For example, in LTE systems, the base station schedules the radio resources (such as the frequency bandwidth and transmission power that can be used in each user terminal) to allocate to each user terminal in TTI units. Note that the definition of the TTI is not limited thereto.

The TTI may be the transmission time unit of channel-encoded data packets (transport blocks), code blocks, codewords, and the like, or may be the unit of processing in scheduling, link adaptation, and the like. Note that, when TTI is given, a time interval (e.g., the number of symbols) in which the transport blocks, the code blocks, the codewords, and the like are actually mapped may be shorter than the TTI.

Note that, when one slot or one mini slot is called a “TTI,” one or more TTIs (i.e., one or multiple slots or one or more mini slots) may be the minimum time unit of scheduling. Also, the number of slots (the number of mini slots) to constitute the minimum time unit of scheduling may be controlled.

A TTI having a time length of 1 ms may be referred to as a usual TTI (TTI in 3GPP Rel. 8 to 12), a normal TTI, a long TTI, a usual subframe, a normal subframe, a long subframe, a slot, and the like. A TTI that is shorter than the usual TTI may be referred to as a shortened TTI, a short TTI, a partial TTI (or fractional TTI), a shortened subframe, a short subframe, a mini slot, a subslot, a slot, and the like.

Note that a long TTI (e.g., a normal TTI, a subframe, etc.) may be replaced with a TTI having a time duration exceeding 1 ms, and a short TTI (e.g., a shortened TTI) may be replaced with a TTI having a TTI duration less than the TTI duration of a long TTI and not less than 1 ms.

A resource block (RB) is the unit of resource allocation in the time domain and the frequency domain, and may include one or a plurality of consecutive subcarriers in the frequency domain. The number of subcarriers in RB may be the same regardless of numerology, and may be 12, for example. The number of subcarriers included in the RB may be determined on the basis of numerology.

Also, an RB may include one or more symbols in the time domain, and may be one slot, one mini slot, one subframe, or one TTI in length. One TTI, one subframe, and the like each may be comprised of one or more resource blocks.

Note that one or a plurality of RBs may be referred to as a physical resource block (Physical RB (PRB)), a sub-carrier group (SCG), a resource element group (REG), a PRB pair, an RB pair, and the like.

Further, the resource block may be constituted by one or a plurality of resource elements (REs). For example, one RE may be a radio resource domain of one subcarrier and one symbol.

The bandwidth part (BWP) (which may be called partial bandwidth and the like) may represent a subset of consecutive common resource blocks (RB) for certain numerology in a certain carrier. Here, the common RB may be specified by an RB index with reference to a common reference point of the carrier. The PRB may be defined in a BWP and numbered within that BWP.

The BWP may include BWP for UL (UL BWP) and BWP for DL (DL BWP). For the UE, one or a plurality of BWPs may be configured within one carrier.

At least one of the configured BWPs may be active, and the UE may not assume to transmit or receive a given signal/channel outside the active BWP. Note that a “cell”, “carrier”, and the like in the present disclosure may be read as a “BWP”.

Note that the structures of radio frames, subframes, slots, mini slots, symbols and so on described above are merely examples. For example, configurations of the number of subframes in a radio frame, the number of slots per subframe or radio frame, the number of mini slots in a slot, the number of symbols and RBs in a slot or a mini slot, the number of subcarriers in RB, the number of symbols in TTI, a symbol length, a cyclic prefix (CP) length, and the like can be variously changed.

Also, the information, parameters, and the like described in the present disclosure may be represented in absolute values or in relative values with respect to given values, or may be represented using other applicable information. For example, a radio resource may be specified by a given index.

The names used for parameters and the like in the present disclosure are in no respect limiting. Further, a mathematical expression and the like using these parameters may differ from those explicitly disclosed in the present disclosure. Various channels (e.g., PUCCH and PDCCH) and information elements can be identified by any suitable name. Various names allocated to these various channels and information elements are in no respect limiting.

The information, signals, and the like described in the present disclosure may be represented using a variety of different techniques. For example, data, instructions, commands, information, signals, bits, symbols, and chips, all of which may be referenced throughout the above description, may be represented by voltages, currents, electromagnetic waves, magnetic fields or particles, optical fields or photons, or any combination of these.

Also, information, signals, and the like can be output in at least one of directions that are from upper layers to lower layers and from lower layers to upper layers. Information, signals, and the like may be input and output via a plurality of network nodes.

The input and/or output information, signals, and the like may be stored in a specific location (e.g., in a memory), or may be managed using a management table. The information, signals, and the like to be input and output can be overwritten, updated or appended. The information, signals and the like that are output may be deleted. The input information, signals, and the like may be transmitted to another apparatus.

Notification of information may be performed not only by using the aspects/embodiments described in the present disclosure but also using another method. For example, notification of information in the present disclosure may be performed by using physical layer signaling (for example, downlink control information (DCI), uplink control information (UCI)), higher layer signaling (for example, radio resource control (RRC) signaling, broadcast information (master information block (MIB), system information block (SIB), or the like), medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message and the like. Further, notification of MAC signaling may be performed using, for example, a MAC control element (MAC CE).

Also, notification of given information (e.g., notification of information to the effect that “X holds”) does not necessarily have to be sent explicitly, and may be sent implicitly (e.g., by not reporting the given information, or by reporting another piece of information).

Determination may be made in values represented by one bit (0 or 1), may be made in Boolean values represented by true or false, or may be made by comparing numerical values (e.g., comparison against a given value).

Software, whether referred to as software, firmware, middleware, microcode, or hardware description language, or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and the like.

Further, software, instruction, information, and the like may be transmitted/received via a transmission medium. For example, when software is transmitted from a website, a server, or other remote sources by using at least one of wired technology (coaxial cable, optical fiber cable, twisted-pair cable, digital subscriber line (DSL), and the like) or wireless technology (infrared light, microwave, and the like), at least one of these wired technology and wireless technology is included in the definition of the transmission medium.

The terms “system” and “network” used in the present disclosure can be used interchangeably. The “network” may mean an apparatus (e.g., base station) included in the network.

In the present disclosure, terms such as “precoding”, “precoder”, “weight (precoding weight)”, “quasi-Co-Location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be interchangeably used.

In the present disclosure, the terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, “component carrier”, and the like may be interchangeably used. The base station may be referred to by a term such as a macro cell, a small cell, a femto cell, a pico cell, and the like.

The base station can accommodate one or a plurality of (for example, three) cells. When a base station accommodates a plurality of cells, the entire coverage area of the base station can be partitioned into a plurality of smaller areas. Each smaller area can provide communication service through a base station subsystem (e.g., indoor small base station (remote radio head (RRH))). The term “cell” or “sector” refers to a part or the whole of a coverage area of at least one of a base station and a base station subsystem that perform a communication service in this coverage.

In the present disclosure, the terms such as mobile station (MS)”, “user terminal”, “user terminal (UE)”, and “terminal” can be used interchangeably.

A mobile station may be called a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or the mobile station may be referred to as a transmitting apparatus, a receiving apparatus, a radio communication apparatus, and the like. Note that at least one of the base station and the mobile station may be a device mounted on a moving object, a moving object itself and the like. The moving object may be a vehicle (for example, a car, an airplane and the like), an unmanned moving object (for example, a drone, an autonomous car, and the like), or a (manned or unmanned) robot. Note that at least one of the base station and the mobile station includes an apparatus that does not necessarily move during a communication operation. For example, at least one of the base station and the mobile station may be Internet of Things (IoT) device such as a sensor.

Further, the base station in the present disclosure may be replaced with user terminal. For example, each aspect/embodiment of the present disclosure may be applied to a configuration in which communication between the base station and the user terminal is replaced with communication between a plurality of pieces of user terminal (which may be referred to as, for example, device-to-device (D2D) and vehicle-to-everything (V2X)). In this case, the user terminal 20 may be configured to have the functions of the base station 10 described above. Further, the wording such as “uplink” and “downlink” may be replaced with the wording corresponding to the terminal-to-terminal communication (for example, “side”). For example, an uplink channel, a downlink channel, and the like may be interpreted as a side channel.

Likewise, a user terminal in the present disclosure may be interpreted as a base station. In this case, the base station 10 may have the functions of the user terminal 20 described above.

In the present disclosure, the operation performed by the base station may be performed by an upper node thereof in some cases. In a network including one or a plurality of network nodes with a base station, it is clear that various operations performed so as to communicate with a terminal can be performed by a base station, one or more of network nodes (e.g., mobility management entity (MME) and serving-gateway (S-GW) may be possible, but are not limiting) other than the base station, or a combination thereof.

The aspects/embodiments described in the present disclosure may be used individually or in combinations, which may be switched depending on the mode of implementation. Further, the order of processing procedures, sequences, flowcharts, and the like of the aspects/embodiments described in the present disclosure may be re-ordered as long as inconsistencies do not arise. For example, although various methods have been shown in the present disclosure with various components of steps using exemplary orders, the specific orders that are shown herein are by no means limiting.

Each aspect/embodiment described in the present disclosure may be applied to a system using long term evolution (LTE), LTE-Advanced (LTE-A), LTE-Beyond (LTE-B), SUPER 3G, IMT-Advanced, 4th generation mobile communication system (4G), 5th generation mobile communication system (5G), future radio access (FRA), new-radio access technology (New-RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), and other appropriate radio communication methods, a next generation system expanded based thereon, and the like. Furthermore, a plurality of systems may be combined to be applied (for example, a combination of LTE or LTE-A and 5G).

The phrase “on the basis of” (or “based on”) as used in the present disclosure does not mean “only on the basis of” (or “based only on”), unless otherwise specified. In other words, the phrase “on the basis of” means both “only on the basis of” (or “based only on”) and “at least on the basis of” (or “based at least on”.)

Reference to elements with designations such as “first,” “second”, and the like as used in the present disclosure does not generally limit the number/quantity or order of these elements. These designations may be used in the present disclosure as a method convenient in distinguishing between two or more elements. In this way, reference to the first and second elements does not imply that only two elements may be employed, or that the first element must precede the second element in some way.

The term “determining” as used in the present disclosure may encompass a wide variety of operations. For example, “determining” may be regarded as judging, calculating, computing, processing, deriving, investigating, looking up, search, inquiry (e.g., looking up in a table, database, or another data structure), ascertaining, and the like.

Furthermore, “determining” as used herein may be interpreted to mean making determination related to receiving (e.g., receiving information), transmitting (e.g., transmitting information), inputting, outputting, accessing (e.g., accessing data in a memory), and the like.

In addition, “determining” as used herein may be interpreted to mean making determination related to resolving, selecting, choosing, establishing, comparing, and the like. In other words, “determining” as used herein may be interpreted to mean making determination related to some operations.

In addition, “determining” as used herein may be interpreted to mean “assuming”, “expecting”, “considering”, and the like.

As used in the present disclosure, the terms “connected” and “coupled,” or any variation of these terms mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.”

As used in the present disclosure, when two elements are connected, these elements may be considered “connected” or “coupled” to each other by using one or more electrical wires, cables, printed electrical connections, and the like, and, as some non-limiting and non-inclusive examples, by using electromagnetic energy, such as electromagnetic energy having wavelengths in the radio frequency, microwave, and optical (both visible and invisible) domains.

In the present disclosure, the phrase “A and B are different” may mean “A and B are different from each other.” Note that the phrase may mean that “A and B are different from C”. The terms such as “separated”, “coupled”, and the like may be similarly interpreted as “different”.

When terms such as “include,” “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, where translations add articles, such as a, an, and the in English, the present disclosure may include that the noun that follows these articles is in the plural.

Although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Therefore, the description in the present disclosure is provided for the purpose of describing examples, and thus, should by no means be construed to limit the invention according to the present disclosure in any way.

1. A radio communication apparatus comprising:
a transmitting/receiving section that performs transmission and reception with another terminal; and
a control section that performs control to share at least one of information regarding a transmission configuration indicator state (TCI state), information regarding quasi-co-location (QCL), and position information with the another terminal.

2. The terminal according to claim 1, wherein the control section determines terminals belonging to a same group on a basis of at least one of information regarding a TCI state of the another terminal, information regarding QCL, and position information, or configuration information from a base station.

3. The terminal according to claim 1, wherein the control section transmits information regarding at least one of beam management and beam recovery request of the another terminal to a base station on a basis of a notification from the another terminal.

4. The terminal according to claim 1, wherein the transmitting/receiving section receives a TCI state switching request from the another terminal, and the control section transmits the TCI state switching request of the another terminal to a base station.

5. The terminal according to claim 1, wherein the transmitting/receiving section transmits at least one of information regarding beam management, information regarding beam recovery request, information regarding TCI state, and information regarding QCL notified from a base station to the another terminal.

6. A radio communication method comprising the steps of:
performing transmission and reception with another terminal; and
performing control to share at least one of information regarding a transmission configuration indicator state (TCI state), information regarding quasi-co-location (QCL), and position information with the another terminal.

7. The terminal according to claim 2, wherein the control section transmits information regarding at least one of beam management and beam recovery request of the another terminal to a base station on a basis of a notification from the another terminal.

8. The terminal according to claim 2, wherein the transmitting/receiving section receives a TCI state switching request from the another terminal, and the control section transmits the TCI state switching request of the another terminal to a base station.

9. The terminal according to claim 3, wherein the transmitting/receiving section receives a TCI state switching request from the another terminal, and the control section transmits the TCI state switching request of the another terminal to a base station.

10. The terminal according to claim 2, wherein the transmitting/receiving section transmits at least one of information regarding beam management, information regarding beam recovery request, information regarding TCI state, and information regarding QCL notified from a base station to the another terminal.

11. The terminal according to claim 3, wherein the transmitting/receiving section transmits at least one of information regarding beam management, information regarding beam recovery request, information regarding TCI state, and information regarding QCL notified from a base station to the another terminal.

12. The terminal according to claim 4, wherein the transmitting/receiving section transmits at least one of information regarding beam management, information regarding beam recovery request, information regarding TCI state, and information regarding QCL notified from a base station to the another terminal.
